(19) United States
(12) Patent Application Publication
(10) Pub. No.: US 2012/0196036 A1
(43) Pub. Date: Aug. 2, 2012

(54) METHOD OF MASS-PRODUCTION OF EYEGLASS LENS

(75) Inventor: Eiichi YAJIMA, Shinjuku-ku (JP)

(73) Assignee: HOYA CORPORATION, Tokyo (JP)

(21) Appl. No.: 13/338,439

(22) Filed: Dec. 28, 2011

(30) Foreign Application Priority Data
Dec. 28, 2010 (JP) 2010-292705

(51) Int. Cl. B05D 5/06

(52) U.S. Cl. 427/162

(57) ABSTRACT

An aspect of the present invention relates to a method of mass producing eyeglass lenses in which formation of a functional film through a primer layer positioned either directly or indirectly on a substrate is simultaneously or sequentially conducted on multiple substrates to obtain multiple finished lenses, which comprises with regard to a surface on which a primer layer is directly formed, determining a reference surface in the form of a surface that has been subjected to processing under conditions identical to conditions in processing to which a surface, on which a primer layer is formed during mass production of finished lenses, is subjected, determining a film thickness of a primer layer to be formed based on a surface roughness of the reference surface thus determined, and forming a functional film after forming a primer layer of determined thickness.

### CROSS-REFERENCE TO RELATED APPLICATIONS

This application claims the benefit of priority under 35 USC 119 to Japanese Patent Application No. 2010-292705 filed on Dec. 28, 2010, which is expressly incorporated herein by reference in its entirety.

### BACKGROUND OF THE INVENTION

1. Field of the Invention

The present invention relates to a method of mass producing eyeglass lenses, and more particularly, to a method of mass producing eyeglass lenses making it possible to stably supply high-quality finished lenses by reducing the variation in adhesion between a substrate and a functional film, or between functional films, in finished lenses.

2. Discussion of the Background

The practice of forming various functional films on a lens substrate to impart desired performance to an eyeglass lens is widespread. For example, in an eyeglass lens (polarizing lens) in which a polarizing film comprising a dichroic dye is provided on a lens substrate, an anti-glare property is achieved by means of the polarizing property of the dichroic dye. Such eyeglass lenses are employed as anti-glare lenses in welding operations, medical treatments, and various sports such as skiing. Methods of manufacturing such polarizing lenses are disclosed in, for example, Reference 1 (Published Japanese Translation (TOKUHYO) No. 2008-527401 of a PCT International Application) or English language family members US2006/146234A1, U.S. Pat. No. 7,625,626, US2010/028532A1, and U.S. Pat. No. 7,922,847; Reference 2 (Japanese Unexamined Patent Publication (KOKAI) No. 2009-237361) or English language family member US2011/102892A1; Reference 3 (International Patent Publication No. 2008/106034); Reference 4 (International Publication No. 2009/029198); Reference 5 (Japanese Unexamined Patent Publication (KOKAI) No. 2010-256895); Reference 6 (Japanese Unexamined Patent Publication (KOKAI) No. 2010-134424) or English language family member US2010/104745A1; and Reference 7 (Japanese Unexamined Patent Publication (KOKAI) No. 2010-102234) or English language family member US2010/104745A1, which are expressly incorporated herein by reference in their entirety.

As is described in above References 1 to 7, a functional film is normally provided on a polarizing film to enhance durability and impart various functions in a polarizing lens. However, when adhesion between the polarizing film and functional film is poor, the functional film will sometimes separate from the main lens body during storage or use. To prevent such phenomena, it is effective to provide a primer layer, playing the role of an adhesive layer to increase adhesion between the polarizing film and functional film, between the polarizing film and the functional film. A primer layer is effective for increasing adhesion between a substrate and a functional film, and adhesion between functional films, not just in polarizing lenses, but also in eyeglass lenses.

To stably supply high-quality eyeglass lenses, it is desirable for substantial variation not to be present in the adhesion achieved by means of the primer layer between the finished lenses being mass produced. However, as a result of research, the present inventor determined that when mass producing eyeglass lenses, there is sometimes a large amount of variation in the adhesion-enhancing effect of the primer layer even with the same primer layer materials and under the same formation conditions.

### SUMMARY OF THE INVENTION

Under such situations, an aspect of the present invention provides for a method of mass producing eyeglass lenses making it possible to obtain a stable supply of high-quality eyeglass lenses.

The present inventor conducted extensive research into achieving the above object. As a result, he surmised the following mechanism relating to the film thickness and adhesion of the primer layer.

When forming a functional film through a primer layer positioned either directly or indirectly on a substrate, spots may exist where the primer layer is not present, allowing the functional film to come into direct contact with the surface on which it is formed in portions of the junction between the surface on which the primer layer is formed (the surface upon which the primer is directly formed; specifically, the substrate surface or the functional film surface that is the outermost surface formed on the substrate) and the functional film formed on the primer layer. When a force to separate the functional film from the primer layer is applied, stress concentrates in such spots, the film begins to separate at such spots, and adhesion decreases.

Based on this mechanism, the drop in adhesion can be prevented by applying a suitably thick primer layer so that no missed spots are present in the primer layer. Additionally, since the film-forming material of the primer layer is generally expensive, it is advantageous from the perspective of cost to employ as thin a primer layer as possible.

Accordingly, the present inventor conducted extensive research to discover indexes making it possible to form a thin primer layer within a scope permitting a reduction in variation in the adhesion between eyeglass lenses being mass produced. As a result, he discovered that with regard to the surface on which the primer layer is formed, by determining a reference surface in the form of a surface that has been subjected to processing under conditions identical to the processing to which the surface on which the primer layer is formed during the mass production of finished lenses, and by determining the film thickness of the primer layer to be formed based on the surface roughness of the reference surface thus determined, it was possible to inhibit the occurrence of variation in the adhesion between mass-produced eyeglass lenses. This was attributed to inhibiting the frequency of occurrence of spots (the above spots of concentrated stress) where the roughness of the surface on which the primer layer was formed was not adequately masked.

The present invention was devised based on the above knowledge.

An aspect of the present invention relates to a method of mass producing eyeglass lenses in which formation of a functional film through a primer layer positioned either directly or indirectly on a substrate is simultaneously or sequentially conducted on multiple substrates to obtain multiple finished lenses, which comprises:

with regard to a surface on which a primer layer is directly formed, determining a reference surface in the form of a surface that has been subjected to processing under conditions identical to conditions in processing to which a surface, on which a primer layer is formed during mass production of finished lenses, is subjected,

determining a film thickness of a primer layer to be formed based on a surface roughness of the reference surface thus determined, and

forming a functional film after forming a primer layer of determined thickness.

The above surface roughness may be a maximum height roughness, Rmax.

In an embodiment of the method of mass producing, the mass production of finished lenses comprises forming a primer layer directly on a functional film formed on a substrate, and the reference surface is a surface of a functional film formed under conditions identical to conditions under which the functional film, directly on which a primer layer is formed, is formed.

The above functional film directly on which a primer layer is formed may be a polarizing film having a polarizing function.

In another embodiment of the method of mass producing, the mass production of finished lenses comprises forming a primer layer directly on a surface of a substrate, and the reference surface is a surface of a substrate subjected to surface processing under conditions identical to conditions under which the surface of the substrate is subjected to surface processing.

The present invention makes it possible to avoid the occurrence of substantial variation in adhesion between mass-produced eyeglass lenses. That makes it possible to stably supply high-quality eyeglass lenses.

### BRIEF DESCRIPTION OF THE DRAWINGS

FIG. 1 is a graph showing the relation between the film thickness of the primer layer and adhesion evaluation results in mass-produced eyeglass lenses in Examples.

### DETAILED DESCRIPTION OF THE EMBODIMENTS

The present invention relates to a method of mass producing eyeglass lenses in which formation of a functional film through a primer layer positioned either directly or indirectly on a substrate is simultaneously or sequentially conducted on multiple substrates to obtain multiple finished lenses. The method of mass producing eyeglass lenses of the present invention comprises, with regard to a surface on which a primer layer is directly formed, determining a reference surface in the form of a surface that has been subjected to processing under conditions identical to conditions in processing to which a surface, on which a primer layer is formed during mass production of finished lenses, is subjected, determining a film thickness of a primer layer to be formed based on a surface roughness of the reference surface thus determined, and forming a functional film after forming a primer layer of determined thickness.

As set forth above, the present inventor has a presumed mechanism that, when there are spots where the surface on which the primer layer is formed comes into direct contact with the functional layer without adequate masking of the surface on which the primer layer is formed, these spots become starting points that decreases adhesion. Accordingly, by determining the film thickness of the primer layer that is formed during the mass production of finished lenses based on the surface roughness of a surface serving as a reference (reference surface) for the roughness of the surface on which the primer layer is formed in the form of a surface that has been processed under the same conditions as the processing that is conducted on the surface on which the primer layer is formed during the mass production of finished lenses, it becomes possible to form a primer layer of a thickness adequate to mask the roughness of the surface on which the primer layer is formed. As a result, it is possible to decrease the variation in adhesion. In reality, by forming a primer layer of a thickness equal to or greater than a prescribed value relative to the surface roughness of the reference surface of the surface on which the primer layer is formed in Examples set forth below, it is possible to inhibit substantial variation in adhesion between mass produced eyeglass lenses. The mechanism presumed by the present inventor is thought to be valid.

The method of mass producing eyeglass lenses of the present invention is described in greater detail below.

The substrate employed to mass produce finished lenses in the present invention is not specifically limited. Substrates such as the plastics and inorganic glasses that are commonly employed as substrates in eyeglass lenses can be used. The surface can be of any shape, such as planar, convex, or concave. The thickness of the substrate is usually about 0.5 to 30 mm in common eyeglass lenses.

The surface on which the primer layer is formed is the surface of the substrate when the primer layer is directly formed on the substrate. When at least one functional film is formed between the substrate and the primer layer in a finished lens, the surface on which the primer layer is formed is a surface of the functional film directly beneath the primer layer. The functional film that is formed between the substrate and the primer layer is determined based on the type of eyeglass lens. For example, in the case of a polarizing lens, at least a polarizing film is formed to impart a polarizing function to the eyeglass lens. The polarizing film is desirably formed by coating a coating liquid containing a dichroic dye, preferably on an orienting layer provided on the substrate, and as needed, using known methods to treat the dichroic dye to render it insoluble in water and immobilize it (form a dye-protecting layer). When a polarizing lens is mass produced as an eyeglass lens by the present invention, any known method can be applied without limitation in the step of manufacturing the polarizing lens. For the details of the step of manufacturing the polarizing lens, reference can be made to the contents of above References 1 to 7, for example.

There are also cases where a hard coat layer is formed between the substrate and the primer layer to increase the durability of the eyeglass lens. The hard coat layer is not specifically limited. For example, a coating cured by heat treating a thermosetting composition, such as a coating in which a microparticulate metal oxide has been added to an organic silicon compound, can be employed. For the details of thermosetting hard coat layers, for example, reference can be made to paragraphs [0071] to [0074] in Japanese Unexamined Patent Publication (KOKAI) No. 2007-77327 and to paragraph [0027] in Japanese Unexamined Patent Publication (KOKAI) No. 2009-237361. Known electron beam-curable resins and ultraviolet radiation-curable resins such as acrylate monomers and oligomers can be employed as hard coat-forming coating compositions, and cured by irradiation with an electron beam or ultraviolet radiation to form a hard coat layer. The thickness of the hard coat layer is not specifically limited, and can be, for example, about 0.5 to 10 μm. Lens substrates with hard coats are commercially available, and can be employed in the present invention.

The primer layer that is employed is not specifically limited other than that it be a layer comprised of a material performing the role of an adhesive layer increasing adhesion between the surface on which the primer layer is formed and the functional film that is provided on the primer layer. Desirable examples are coated films formed by coating an olefin-based, acrylic-based, epoxy-based, or urethane-based resin solution in the form of a polyurethane resin, vinyl acetate, or ethylene-vinyl copolymer. A waterborne resin layer formed of a waterborne resin composition containing a resin component and an aqueous solvent is desirable because it can be used to form a film by removing the solvent by drying without undergoing a heat treatment (curing) at a high temperature, facilitating film formation.

In the above waterborne resin composition, examples of resin components are polyurethane resins, acrylic resins, and epoxy resins. From the perspective of adhesion, the resin component is desirably a polyurethane resin. A waterborne resin composition containing a polyurethane resin, that is, a waterborne polyurethane resin composition, can be prepared by, for example, subjecting a high-molecular-weight polyol compound, an organic polyisocyanate compound, and, as needed, a chain-extending agent to a urethane-forming reaction in a solvent with good affinity for water that is inert with respect to the reaction to obtain a prepolymer; neutralizing the prepolymer; and dispersing it in an aqueous solvent containing a chain-extending agent to increase the molecular weight. For such waterborne polyurethane resin compositions and methods of preparing them, reference can be made to, for example, paragraphs [0009] to [0013] of Japanese Patent No. 3,588,375, paragraphs [0012] to [0021] of Japanese Unexamined Patent Publication (KOKAI) Heisei No. 8-34897, paragraphs [0010] to [0033] of Japanese Unexamined Patent Publication (KOKAI) Heisei No. 11-92653, and paragraphs [0010] to [0033] of Japanese Unexamined Patent Publication (KOKAI) Heisei No. 11-92655. The content of the above publications are expressly incorporated herein by reference in their entirety. The above waterborne polyurethane resin composition can be employed in the form of a commercially available water-based urethane as is, or diluted with an aqueous solution as needed. Examples of commercially available waterborne polyurethanes are the “Adeka Bontighter” series made by Asahi Denka Kogyo, K.K.; the “Olester” series made by Mitsui-Toatsu Chemicals, Inc.; the “Bondick” and “Hydran” series made by Dainippon Ink and Chemicals; Corporation; the “Impranil” series made by Bayer; the “Sofranate” series made by Japan Sofran; the “Poise” series made by Kao; the “Sanprene” series made by Sanyo Chemical Industries, Ltd.; the “Izelax” series made by Hodogaya Chemical Co., Ltd.; the “Superflex” series made by Daiichi Yakuhin Kougyou Co., Ltd.; and the “Neo Rez” series made by Zeneca.

The waterborne polyurethane resin composition can be coated and dried on the surface on which the primer layer is to be formed—for example, a polarizing film surface on which a dichroic dye has been immobilized—to form a waterborne resin layer as a primer layer. A known coating method such as dipping or spin coating can be employed. It suffices to suitably set the coating conditions so as to form a primer layer of the thickness determined by the method described further below.

The method of determining the thickness of the primer layer that is formed during the mass production of finished lenses will be described next.

As set forth above, it is possible to reduce the occurrence of spots at which the functional film formed on the primer layer and the surface on which the primer layer is formed come into direct contact without the presence of the primer layer by forming a primer layer of a thickness capable of masking the roughness of the surface on which the primer layer is formed. Thus, the variation in adhesion between finished lenses can be inhibited.

Accordingly, in the present invention, the film thickness of the primer layer that is to be formed is determined based on the surface roughness of a reference surface in the fowl of the surface on which the primer is to be formed to permit the formation of a primer layer of a thickness that is adequate to mask the roughness of the surface on which the primer layer is formed. The reference surface is desirably of a roughness that is identical or similar to the roughness of the surface on which the primer layer is to be formed during the mass production of eyeglass lenses from the perspective of effectively reducing variation in the adhesion between the lenses being mass produced. For that reason, in the present invention, the reference surface is specified as a surface that has been subjected to processing under the same conditions as the processing to which the surface on which the primer layer is formed during the mass production of finished lenses. That surface is preferably comprised of the same material, or a material having a composition that is similar to, the surface on which the primer layer is formed during the mass production of finished lenses. Specifically, when the surface on which the primer layer is being formed is a polarizing film surface, an example is a polarizing film surface that has been processed under the same conditions as the processing (such as water-insolubility processing and subsequent immobilization processing) to which the polarizing film surface is subjected during the mass processing of finished lenses. The reference surface can also be manufactured by a different process than on the mass-production line as a sample for determining the film thickness of the primer layer during the mass production of finished lenses, or extracted from the mass production line. In the latter case, when the surface on which the primer layer is formed is the substrate surface, the reference surface can be the surface of at least one substrate extracted from the substrate lot that is being used in the mass production of finished lenses. When a surface treatment such as an alkali treatment is being conducted during the mass production of finished lenses, the reference surface can be a substrate surface that has been subjected to such a treatment. When the surface on which the primer layer is formed is the surface of a functional film formed on the substrate, the reference surface can be the surface of a functional film on a lens extracted from the lens lot that has been processed up to and including the formation of the functional film during the mass production of finished lenses. The substrate extracted from the substrate lot or the lens extracted from the lens lot can be returned to the production line following surface roughness measurement and employed to manufacture a finished lens, or can be removed from the production line and from the manufacturing of finished lenses.

The surface roughness of the reference surface can be measured by a known method. Surface roughness measurement by an atomic force microscope (AFM) can be conducted in accordance with the method of JIS R1683 (2007). The measurement area can be any range, such as 1 μm×1 μm, 10 μm×10 μm, or 30 μm×30 μm, and one or more measurement sites can be employed.

Examples of the surface roughness serving as an index to determine the film thickness of the primer layer are: the maximum height roughness Rmax (Rz in JIS B0601 (2001)), the arithmetic average roughness Ra, the maximum peak height Rp, and the maximum valley depth Rv (the above being defined as in JIS B0601 (2001)). The film thickness of the primer layer formed during the mass production of finished lenses can be determined based on any one or more of these. Of these, Rmax is the maximum value of the gap between any peak and valley in the measured region. When the film thickness of the primer layer is determined based on this gap, it is thought that the probability of the surface on which the primer layer is formed coming into direct contact with the functional film without the roughness of the surface on which the primer layer is formed being masked by the primer layer is reduced. In reality, in Examples set forth further below, by using Rmax as an index, the film thickness of the primer layer is determined in a manner effectively inhibiting variation in adhesion between eyeglass lenses that are mass produced. Accordingly, in the present invention, it is desirable to determine the film thickness of the primer layer during the mass production of finished lenses based on the Rmax of the reference surface. For example, by making the Rmax of the reference surface the lower limit of the film thickness of the primer layer formed during the mass production of finished lenses, as disclosed in Examples described further below, the variation in adhesion between the lenses that are mass produced can be extremely effectively inhibited. However, in the present invention, the lower limit of the film thickness of the primer layer formed during the mass production of finished lenses is not limited to the Rmax of the reference surface; it need only be determined based on the surface roughness of the reference surface to within the quality required in the finished lens. Further, the upper limit of the film thickness of the primer layer formed during the mass production of finished lenses can also be determined based on the surface roughness of the reference surface. For example, in Examples set forth further below, when the film thickness of the primer layer is greater than or equal to the Rmax of the reference surface, the variation in adhesion between mass produced eyeglass lenses can be extremely effectively inhibited. Thus, a margin beyond Rmax can be provided. For example, if the upper limit is set to about Rmax×1.2 to 1.5, the possibility of manufacturing finished lenses with poor adhesion in the mass production process can be nearly excluded. Thus, it is possible to avoid forming excessively thick primer layers to reduce the variation in adhesion between finished lenses. As set forth above, the film material of the primer layer is generally expensive, so this aspect is extremely advantageous in terms of cost.

To more effectively reduce the variation in adhesion between finished lenses during the mass production of finished lenses, it is desirable to prepare multiple laminated samples in which a primer layer and functional film are formed on a surface in the same state as the reference surface while varying the film thickness of the primer layer, and to obtain the correlation between the variation in adhesion in these laminated samples and the surface roughness of the surface on which the primer layer is formed in a reference sample in a test lamination step. In this test lamination step, the range in which great variation in adhesion is not produced between the laminate samples that are prepared can be determined as the lower limit film thickness. So long as a primer layer of a film thickness greater than or equal to the above lower limit is formed during the mass production of finished lenses, the variation in adhesion between the finished lenses that are produced can be reduced.

The details of the method of forming a primer layer of the determined thickness are as set forth above. Examples of functional films that are directly provided on primer layers that are formed are: hard coat films, anti-reflective films, water-repellent films, UV-absorbing films, IR-absorbing films, photochromic films, and antistatic films. The functional film that is provided on the primer layer is not limited to a single layer; two or more layers can be laminated. The thickness thereof is not specifically limited, and can be suitably set based on the desired function.

A desirable example of a functional film that is directly provided on a primer layer is a hard coat layer. Forming a hard coat layer can yield an eyeglass lens with good scratch resistance. The details of the hard coat layer are as set forth above. The thickness of a hard coat layer that is formed on a primer layer is desirably about 0.5 to 10 μm from the perspective of imparting good shock resistance to the eyeglass lens obtained.

Part or all of the steps can be conducted on the object being processed on an eyeglass mass production line either simultaneously or sequentially. For example, vacuum vapor deposition processing in a vacuum vapor deposition device, thermal processing in a furnace, and the like can be conducted simultaneously on multiple objects being processed, and the coating step can be conducted sequentially on multiple objects being processed.

The present invention as set forth above can reduce the variation in adhesion between eyeglass lenses being mass produced and thus can provide a stable supply of high-quality eyeglass lenses.

The present invention can also avoid forming an excessively thick primer layer to reduce the variation in adhesion between eyeglass lenses that are being mass produced, thereby preventing an increase in cost due to the formation of the primer layer.

### EXAMPLES

The present invention will be further described based on Examples below. However, the present invention is not limited to the embodiments shown in Examples.

1. Mass Production of Eyeglass Lenses (Polarizing Lenses)

### (1) Forming an Orienting Layer

A Phoenix lens (made by HOYA CORPORATION, refractive index 1.53, with hard coat, diameter 70 mm, base curve 4, center thickness 1.5 mm) was employed as the lens substrate. A SiO₂ film 0.2 μm in thickness was formed by vacuum vapor deposition on the concave surface of the lens.

Abrasive-containing urethane foam (abrasive: Al₂O₃ particles with an average particle diameter of 0.8 μm, product name POLIPLA 203A, made by Fujimi Inc.; urethane foam: approximately the same shape as the curvature of the concave surface of the above lens) was employed to subject the SiO₂ film that had been formed to uniaxial polishing under conditions of a rotational speed of 350 rpm at a polishing pressure of 50 g/cm² for 30 seconds. The polished lens was rinsed in pure water and dried.

### (2) Forming a Polarizing Film

After drying the lens, 2 to 3 g of an aqueous solution of roughly 5 mass percent of water-soluble dichroic dye (product name Varilight solution 2S, made by Sterling Optics, Inc.) was spin coated on the polished surface to form a polarizing film. In the spin coating, the aqueous solution of dye was fed at a rotational speed of 300 rpm, which was maintained for 8 seconds, after which a rotational speed of 400 rpm was maintained for 45 seconds, followed by 1,000 rpm maintained for 12 seconds.

Next, an aqueous solution with an iron chloride concentration of 0.15 M, a calcium hydroxide concentration of 0.2 M, and a pH of 3.5 was prepared. The lens obtained above was immersed for about 30 seconds in the aqueous solution, withdrawn, and thoroughly rinsed in pure water. This step rendered the originally water-soluble dye insoluble (water insolubilization treatment).

### (3) Immobilization Treatment

Following (2) above, the lens was immersed for 15 minutes in a 10 mass percent aqueous solution of γ-aminopropyl triethoxysilane. It was then rinsed three times with pure water, heat treated for 30 minutes in a heating furnace (temperature within furnace: 85° C.), removed from the furnace, and cooled to room temperature.

After cooling, the lens was immersed for 30 minutes in a 2 mass percent aqueous solution of γ-glycidoxypropyl trimethoxysilane.

The polarizing film formed by the above processing was about 1 μm in thickness.

### (4) Forming a Waterborne Resin Layer (Primer Layer)

The waterborne polyurethane resin composition was applied by spin coating to the surface of the polarizing film after the immobilization treatment. The waterborne polyurethane resin composition employed comprising Adeka Bontighter HUX-232, a product made by ADEKA Corporation (a water dispersion obtained by dispersing in water a terminal isocyanate prepolymer containing a carboxyl group and having a polyester polyol as the basic skeleton; solid component: 30 mass percent; particle diameter of resin component: less than 0.1 μm; viscosity at 25° C.: 20 mPa·s; pH at 25° C.: 8.5) that had been diluted six-fold in propylene glycol monomethyl ether. After applying the composition onto the polarizing film by spin coating, the lens was dried by being heat treated for 30 minutes in a heating furnace (temperature within furnace: 60° C.), thereby forming a primer layer (waterborne resin layer) on the polarizing film. The spin coating conditions were varied to obtain primer layers of varying thickness.

### (5) Forming a Hard Coat Layer

To a vessel made of glass and equipped with magnetic stirrer were added 17 mass parts of γ-glycidoxypropylmethoxysilane, 30 mass parts of methanol, and 28 mass parts of an aqueous dispersion of colloidal silica (solid component 40 mass percent, average particle diameter 15 nm) and the mixture was thoroughly mixed. The mixture was then stirred for 24 hours at 5° C. Next, 15 mass parts of propylene glycol monomethyl ether, 0.05 mass part of silicone surfactant, and 1.5 mass parts of a curing agent in the form of aluminum acetylacetonate were added and the mixture was thoroughly stirred and filtered to prepare a hard coating solution (hard coat composition). The coating solution was about pH 5.5.

The hard coating composition that had been prepared was coated by dipping (withdrawing rate: 20 cm/minute) on the surface of the primer layer of the lens processed in (4) above and cured by heating for 60 minutes at 100° C. to form a hard coat layer 3 μm in thickness.

Steps (1) to (5) above were applied to multiple lens substrates to mass produce a total of 130 eyeglass lenses (polarizing lenses).

2. Measurement of Surface Roughness of Surface on which the Primer Layer was Formed

The surface roughness of the polarizing film surface (after immobilization treatment) before the formation of the primer layer of one of the 130 lenses prepared in 1. above was measured by an atomic force microscope (Nanoscope D-3000 made by Digital Instruments) under the following conditions. The surface roughness that was measured was a maximum height roughness of Rmax: 141.68 mm

### [Measurement Conditions]

Cantilever: Si monocrystal
Mode: Tapping mode (250 to 280 kHz), in-plane measurement
Measurement area: 30 μm×30 μm

3. Evaluation of Adhesion

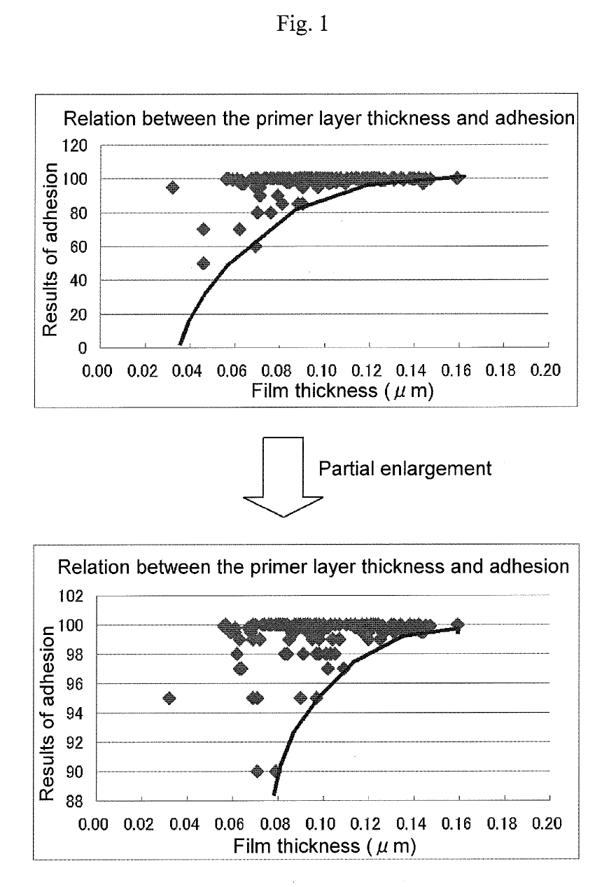

Crosscuts were made at intervals of 1.5 mm on the hard coat layer sides of the 130 polarizing lenses that had been fabricated to form grids comprised of 100 squares. Adhesive tape (cellophane tape made by Nichiban K.K.) was strongly adhered to the spots where the crosscuts had been made, after which the adhesive tape was rapidly pulled away. The number of squares that did not separate from among the 100 squares were then counted. The results are given in FIG. 1.

4. The Relation Between Variation in Adhesion, the Roughness of the Surface on which the Primer Layer was Formed, and the Thickness of the Primer Layer

FIG. 1 is a graph in which the evaluation results of 3. above (the number of squares that did not separate) of the 130 lenses that were fabricated are plotted against the film thickness of the primer layer. The FIGURE beneath it is a partial enlargement thereof.

As measured in 2. above, the maximum height roughness Rmax of the surface on which the primer layer was formed (reference surface) of the lens extracted during mass production was about 0.14 μm. The number of squares that separated from the lens on which the primer layer was formed to a film thickness of equal to or greater than 0.14 μm was 0 to 1 and almost no variation in adhesion was observed between lenses. Thus, forming a primer layer with a film thickness of equal to or greater than the Rmax of the reference surface was confirmed to extremely effectively reduce the variation in adhesion between mass produced lenses. Based on the above results, it is thus possible to determine a film thickness of equal to or greater than the Rmax of the reference surface as the film thickness of the primer layer that is to be formed.

Alternatively, when the number of squares that did not separate in the results given in FIG. 1 was set to a permissible range of 90 to 100, this permissible range was satisfied by a primer layer film thickness of equal to or greater than 0.08 μm. In that case, a film thickness of equal to or greater than the reference surface Rmax×0.57 (that is, 57 percent of the Rmax) can be determined as the film thickness of the primer layer that is to be formed.

Further, by forming a primer layer of the film thickness determined as set forth above in a mass production step, it is possible to avoid substantial adhesion variation between finished lenses and to stably supply high-quality eyeglass lenses.

5. The Relation Between the Surface Roughness of the Lens Substrate and the Thickness of the Primer Layer

### (1) Measurement of the Surface Roughness of the Lens Substrate

An Airy lens (refractive index: 1.70; made by HOYA CORPORATION) was immersed for 270 seconds in a 10 mass percent NaOH aqueous solution as an alkali cleaning treatment.

Following the alkali cleaning treatment, the surface roughness of the convex surface of the lens was measured under the following conditions by an atomic force microscope (Nanoscope D-3000, made by Digital Instruments). The surface roughness measured was a maximum height roughness Rmax of 23 nm.

### [Measurement Conditions]

Cantilever: Si monocrystal
Mode: Tapping mode (250 to 280 kHz), in-plane measurement
Measurement area: 10 μm×10 μm

### (2) Formation of Primer Layer and Hard Coat Layer, and Evaluation of Adhesion

Multiple Airy lenses (refractive index: 1.70; made by HOYA CORPORATION) were subjected to an alkali cleaning treatment identical to that set forth above. Subsequently, a primer layer was formed by the method described in 1.(4) above on the convex surface of each. By varying the spin coating conditions, primer layers of different thicknesses were formed.

A hard coat layer was formed by the method described in 1.(5) on each of the primer layers that had been formed and the adhesion was evaluated by the method described in 3. above.

As a result, the formation of a primer layer to a film thickness exceeding the Rmax measured in (1) above reduced the variation in adhesion between the multiple lenses. The formation of a primer layer to a film thickness of three to four times the Rmax was determined to nearly completely eliminate the variation in adhesion between the multiple lenses.

These results indicated that the variation in adhesion in mass produced lenses could be reduced by determining the film thickness of the primer layer using the surface roughness of a reference surface as an index.

With the exception that the Adeka Bontighter HUX-232, a product made by ADEKA Corporation, was replaced with Adeka Bontighter HUX-350, a product made by ADEKA Corporation containing polyether polyurethane resin as a resin component, and Adeka Bontighter HUX-550, also a product made by ADEKA Corporation, as the waterborne polyurethane resin composition employed to form the primer layer, step 1 (mass production of eyeglass lenses (polarizing lenses)) through step 5 (the relation between the surface roughness of the lens substrate, the thickness of the primer layer, and adhesion) were conducted in the same manner as above. By forming a primer layer with a thickness exceeding the Rmax measured in step 5(1), it was possible to reduce the variation in adhesion between multiple lenses. By forming a primer layer with a thickness 3 to 4 times Rmax, it was determined to be possible to nearly completely eliminate variation in adhesion between multiple lenses.

In the above Examples, Rmax was measured in one spot. However, it is possible to conduct measurement in two or more spots and take the average value or maximum value as an index in determining the film thickness of the primer layer that is formed during the mass production of eyeglass lenses.

The present invention is useful in the field of manufacturing eyeglass lenses.

What is claimed is:

1. A method of mass producing eyeglass lenses in which formation of a functional film through a primer layer positioned either directly or indirectly on a substrate is simultaneously or sequentially conducted on multiple substrates to obtain multiple finished lenses, which comprises:
with regard to a surface on which a primer layer is directly formed, determining a reference surface in the form of a surface that has been subjected to processing under conditions identical to conditions in processing to which a surface, on which a primer layer is formed during mass production of finished lenses, is subjected,
determining a film thickness of a primer layer to be formed based on a surface roughness of the reference surface thus determined, and
forming a functional film after forming a primer layer of determined thickness.

2. The method of mass producing eyeglass lenses according to claim 1, wherein the surface roughness is a maximum height roughness, Rmax.

3. The method of mass producing eyeglass lenses according to claim 1, wherein
the mass production of finished lenses comprises forming a primer layer directly on a functional film formed on a substrate, and
the reference surface is a surface of a functional film formed under conditions identical to conditions under which the functional film, directly on which a primer layer is formed, is formed.

4. The method of mass producing eyeglass lenses according to claim 3, wherein the functional film directly on which a primer layer is formed is a polarizing film having a polarizing function.

5. The method of mass producing eyeglass lenses according to claim 1, wherein
the mass production of finished lenses comprises forming a primer layer directly on a surface of a substrate, and
the reference surface is a surface of a substrate subjected to surface processing under conditions identical to conditions under which the surface of the substrate is subjected to surface processing.
